(19) United States
(12) Patent Application Publication
(10) Pub. No.: US 2011/0240166 A1
(43) Pub. Date: Oct. 6, 2011

(54) INSULATION AND METHODS OF INSULATING

(75) Inventors: Robert P. Collier, Gahanna, OH (US); Brian Patrick O'Riordan, Ashville, OH (US); George A. Bowne, Columbus, OH (US)

(73) Assignee: Owens Corning Intellectual Capital LLC, Toledo, OH (US)

(21) Appl. No.: 13/149,144

(22) Filed: May 31, 2011

Related U.S. Application Data
(60) Provisional application No. 61/466,165, filed on Mar. 22, 2011.

(51) Int. Cl. F16L 9/14; B23P 19/00; B32B 1/06; B32B 3/06

(52) U.S. Cl. 138/149; 29/428; 428/76; 428/99

(57) ABSTRACT

A pipeline and an insulation system for a pipeline are disclosed by the present application. In one exemplary embodiment, a pipeline includes a pipe, insulation disposed around the pipe, a hard outer shell that encases the insulation disposed around the pipe, and a plurality of insulation panels secured around the hard outer shell that encases the insulation disposed around the pipe. The insulation panel includes one or more pieces of compressible fiberglass insulation material having an R value per inch of thickness from about 2 to about 13 hr-sq ft-deg F/Btu measured at 75 degrees Fahrenheit and a coated fabric cover encasing the one or more pieces of insulation material. The coated fabric cover has a weight from about 5 to about 40 oz/sq yd.

### CROSS REFERENCE TO RELATED APPLICATIONS

This application claims priority to U.S. Provisional Patent Application No. 61/466,165, filed Mar. 22, 2011, which is hereby incorporated by reference in its entirety.

### BACKGROUND

Pipelines and other similar structures transport fluids and other materials, such as oil, water, and sewage, over long distances and through various medium, e.g., above ground, below ground, underwater, through marshes, etc. Pipelines are typically exposed to all types of climates, weather, and temperatures. For example, some pipelines may be exposed to extreme climates in which the temperature may reach −65 degrees Fahrenheit or lower. In order to control heat loss from the materials carried within structures such as pipelines, the structures may be insulated.

### SUMMARY

A method of adding insulation to a pipeline, a pipeline, and an insulation panel for a pipeline are disclosed by the present application.

In one exemplary embodiment, a method of adding insulation to a pipeline having an existing insulation system is disclosed. The existing insulation system comprises insulation disposed around a pipe of the pipeline and a hard shell that encases the insulation disposed around the pipe. The method of adding insulation includes delivering an insulation panel to the pipeline. The insulation panel includes one or more pieces of compressible fiberglass insulation material having an R value per inch of thickness from about 2 to about 13 hr-sq ft-deg F/Btu measured at 75 degrees Fahrenheit. The insulation material is configured to return substantially back to its original thickness and density after being compressed. The insulation panel also includes a substantially rectangular coated fabric cover encasing the one or more pieces of insulation material. The coated fabric cover has a weight from about 5 to about 40 oz/sq yd. A first row of spaced apart apertures is disposed along a first side of the coated fabric cover. A second row of spaced apart apertures is connected to the coated fabric cover. The second row of spaced apart apertures is generally parallel to the first row of spaced apart apertures.

The method of adding insulation also includes attaching one or more elongated flexible members to at least one of the apertures. The one or more elongated flexible members are tossed over the top of the existing insulation system. The insulation panel is pulled over the top of the hard shell of the existing insulation system using the one or more elongated flexible members such that the insulation panel is draped over the top of the hard shell of the existing insulation system. Apertures of the first row of spaced apart apertures are attached to apertures of the second row of spaced apart apertures to secure the coated fabric cover around the existing insulation system.

In another exemplary embodiment, a pipeline is disclosed. The pipeline includes a pipe, insulation disposed around the pipe, a hard outer shell that encases the insulation disposed around the pipe, and a plurality of insulation panels secured around the hard outer shell that encases the insulation disposed around the pipe. At least one of the plurality of insulation panels includes one or more pieces of compressible fiberglass insulation material having an R value per inch of thickness from about 2 to about 13 hr-sq ft-deg F/Btu measured at 75 degrees Fahrenheit. The insulation material is configured to return substantially back to its original thickness and density after being compressed. At least one of the plurality of insulation panels also includes a substantially rectangular coated fabric cover encasing the one or more pieces of insulation material. The coated fabric cover has a weight from about 5 to about 40 oz/sq yd. At least one vent is disposed in the coated fabric cover.

In another exemplary embodiment, an insulation panel for adding insulation to a pipeline having an existing insulation system is disclosed. The existing insulation system includes insulation disposed around a pipe of the pipeline and a hard shell that encases the insulation disposed around the pipe. The insulation panel includes one or more pieces of compressible fiberglass insulation material having an R value per inch of thickness from about 2 to about 13 hr-sq ft-deg F/Btu measured at 75 degrees Fahrenheit. The insulation material is configured to return substantially back to its original thickness and density after being compressed. The insulation panel also includes a substantially rectangular coated fabric cover encasing the one or more pieces of insulation material. The coated fabric cover has a weight from about 5 to about 40 oz/sq yd. A first row of spaced apart apertures is disposed along a first side of the coated fabric cover. A second row of spaced apart apertures is connected to the coated fabric cover. The second row of spaced apart apertures is generally parallel to the first row of spaced apart apertures. The first and second rows of spaced apart apertures are configured such that attachment of apertures of the first row of apertures to apertures of the second row of apertures secures the coated fabric cover around the pipeline. At least one vent that permits air to escape from inside the cover when the insulation panel is compressed is disposed in the coated fabric cover.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to example the principles of the inventions.

FIGS. 1A and 1B illustrate a top view and a side view of an insulation panel according to an embodiment of the present application.

FIGS. 2A and 2B illustrate side and end views of an insulation panel according to an embodiment of the present application installed on a pipeline.

FIGS. 3A-3D illustrate top views of various embodiments of an insulation panel of the present application.

FIGS. 4A-4C illustrate top views of various embodiments of an insulation panel of the present application.

FIG. 4D illustrates an end view of an insulation panel according to an embodiment of the present application installed on a pipeline.

FIG. 5 illustrates a top view of an insulation panel according to another embodiment of the present application.

FIGS. 6A-6B illustrate end and side views of an insulation panel according to the embodiment of FIG. 6A installed on a pipeline.

FIG. 7A illustrates a top view of an insulation panel according to yet another embodiment of the present application.

FIGS. 7B-7C illustrate side and end views of an insulation panel according to the embodiment of FIG. 7A installed on a pipeline.

FIG. 8A illustrates a top view of yet another insulation panel according to an embodiment of the present application.

FIG. 8B illustrates a side view of the insulation panel of FIG. 8A installed on a pipeline.

FIG. 9A illustrates a side view of two insulation panels according to yet a further embodiment installed on a pipeline.

FIG. 9B illustrates a side view of two insulation panels according to yet another embodiment of the present application installed on a pipeline.

FIG. 10 illustrates an end view of an insulation panel according to yet an additional embodiment installed on a pipeline.

FIGS. 11A-11F illustrate top views and side views of an insulation panel according to yet another embodiment being installed on a pipeline.

FIGS. 12A and 12B illustrate perspective views of a plurality of insulation panels installed on a pipeline according to another embodiment of the present application.

FIG. 13 illustrates a top view of an embodiment of an insulation panel of the present application installed on a pipeline.

FIG. 14 illustrates an end view of an embodiment of an insulation panel of the present application installed on a pipeline having an existing insulation system.

### DESCRIPTION OF EMBODIMENTS

As described herein, when one or more components are described as being connected, joined, affixed, coupled, attached, or otherwise interconnected, such interconnection may be direct as between the components or may be in direct such as through the use of one or more intermediary components. Also as described herein, reference to a “member,” “component,” or “portion” shall not be limited to a single structural member, component, or element but can include an assembly of components, members or elements.

Insulation and methods of insulating an object are disclosed in the present application. In many exemplary embodiments disclosed herein, insulation panels are described as being used to insulate a pipeline. However, the insulation panels of the present application may be used to insulate any pipe, tube, duct, and/or conduit and are not limited to only pipelines. The insulation panels may also be used to insulate a variety of other objects, such as tanks, vessels, trailers, or railroad cars. The insulation panels of the present application may include thermal and/or acoustical insulation.

The insulation panels may be configured for use in cold weather climates and inclement weather conditions. For example, the insulation panels may be flexible at low temperatures (e.g., −65 degrees F.) such that the panels may be wrapped around a pipeline in cold weather regions. The insulation panels may also be made from a tough, durable, weatherproof material to prohibit damage to the panel from various weather conditions, such as high winds, rain, snow, and ice. As such, the insulation panels may be waterproof and capable of being secured to a pipeline or other object in such a way as to prohibit removal or damage from environmental elements. The insulation panels may also be resistant to ultraviolet light (UV) or sunlight to prohibit degradation of the panel over a period of time (e.g., 10-20 years or longer).

The insulation panels may also be configured to withstand impacts and prohibit damage to the panel from potential hazards, such as animals, vehicles, humans, and various projectiles (e.g., gunshots). The insulation panels may be configured to prohibit tampering, theft, or sabotage of the panel. Further, the insulation panels may be compressible and lightweight to facilitate transportation and installation of the panel on pipelines or other objects in remote regions of the world. The insulation panels may also be capable of being easily repaired if damaged.

An insulation panel generally includes a cover or jacket encasing an insulation material. The cover provides structure to the insulation panel and protects the insulation material from the elements and other potential hazards. The cover is also configured to facilitate installation of the insulation panel on a pipeline or other similar structure.

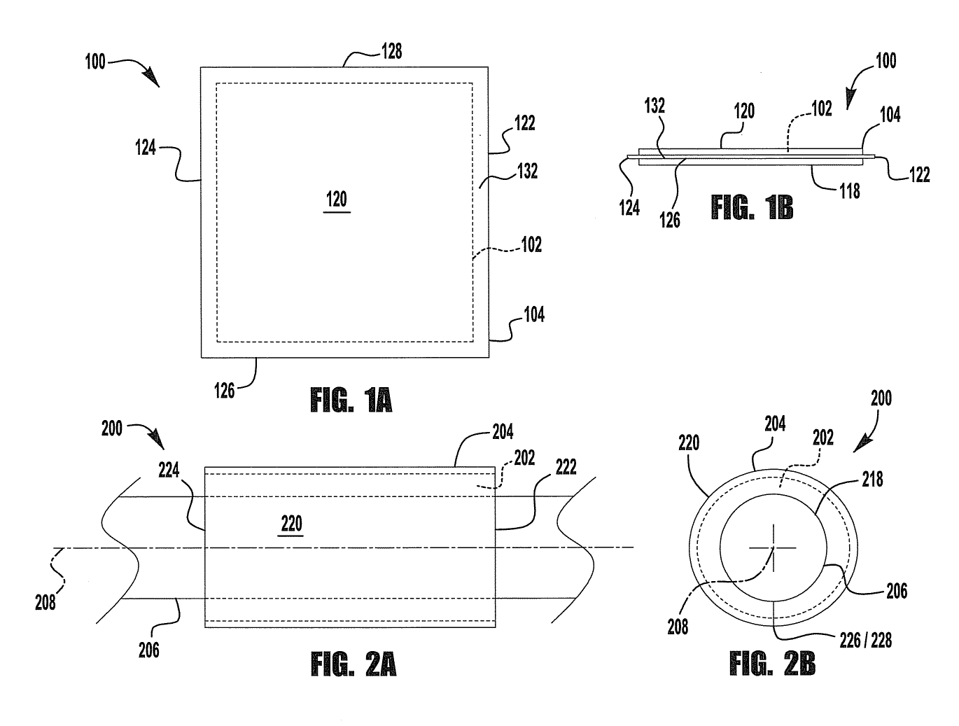

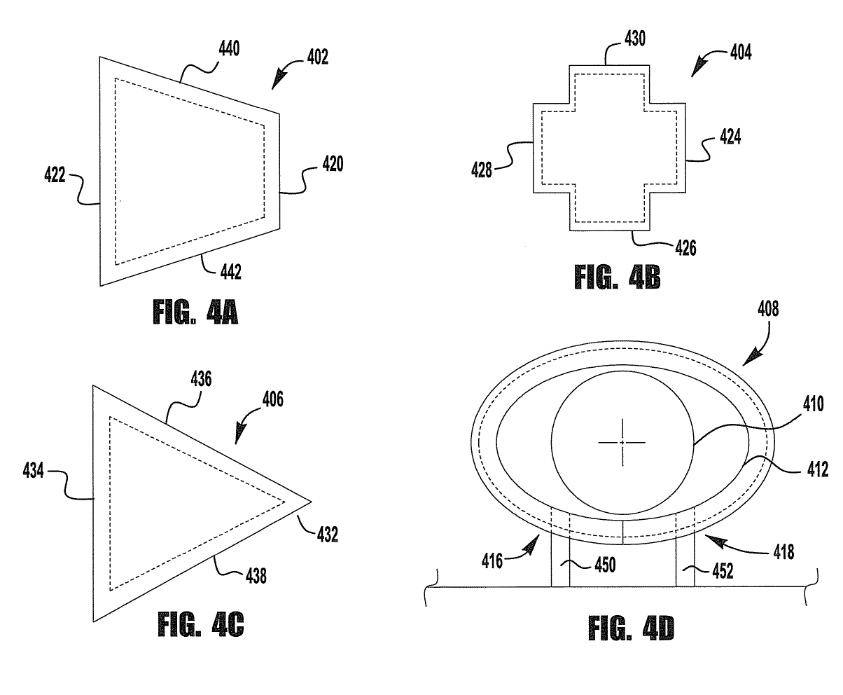

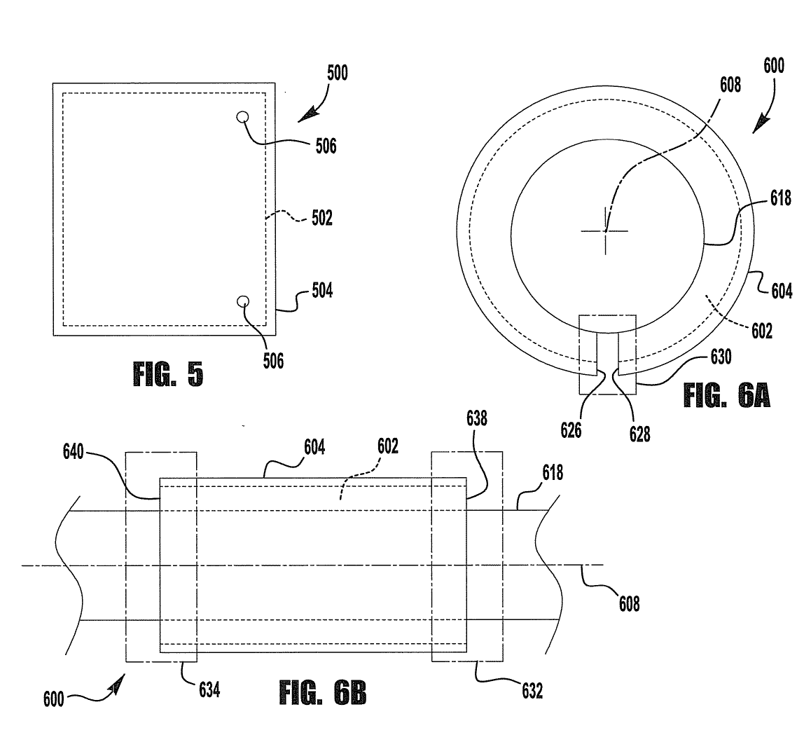

FIGS. 1A and 1B illustrate an insulation panel 100 according to one embodiment. The insulation panel 100 comprises a cover 104 and an insulation material 102. As shown, the insulation material 102 is encased within the cover 104 to form a blanket like structure. The cover 102 may fit tightly or loosely around the insulation material 102. As shown, the insulation panel 100 is rectangular in shape and has a top surface 120, a bottom surface 118 (see FIG. 1B), a first side 122, a second side 124, a third side 126, and a fourth side 128. However, the insulation panel 100 may be a variety of shapes, e.g., circular, square, oval, trapezoidal (see FIG. 4A), cross-shaped (see FIG. 4B), triangular (see FIG. 4C), or other shape, and have more or less surfaces and/or sides.

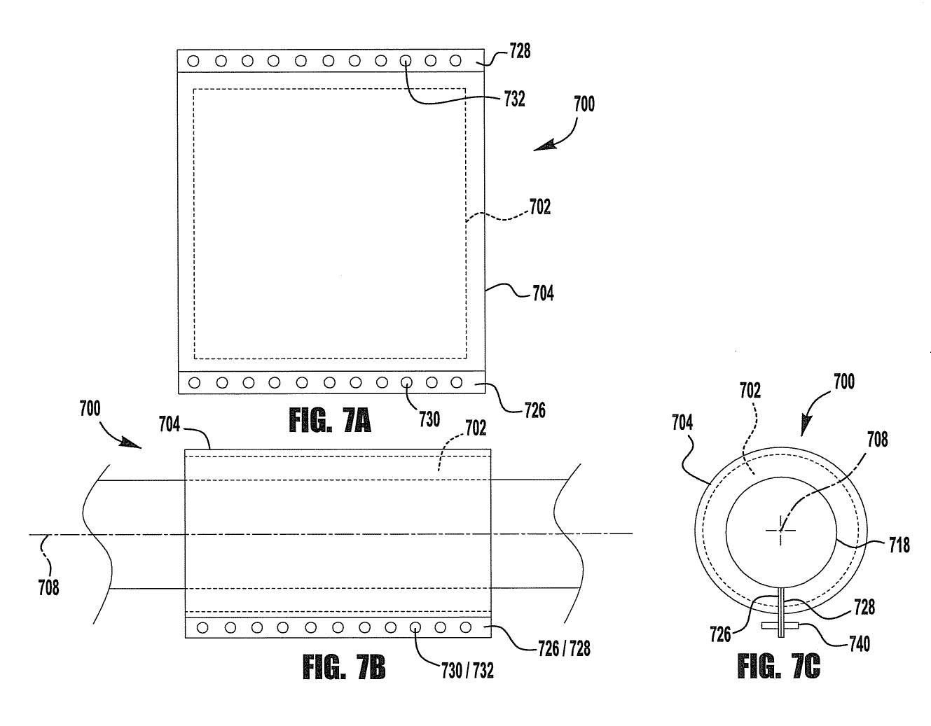

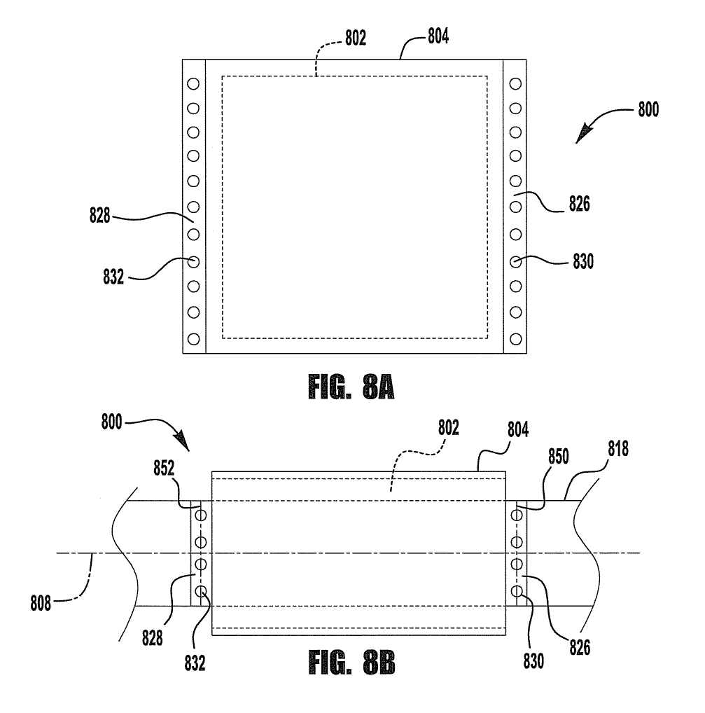

The cover of the insulation panel of the present application may include an outer portion for fastening the insulation panel to a pipeline or other structure. As illustrated in FIGS. 1A and 1B, the cover 104 of the insulation panel 100 includes a flat, outer portion 132 around the insulation material 102. The outer portion 132 extends along all four sides of the insulation panel 100. As illustrated in FIG. 1B, the outer portion 132 also extends from a middle portion of the sides of the insulation panel 100. The outer portion 132 may be used as a fastening area to secure the insulation panel 100 to the pipeline or other structure. For example, as discussed below and shown in FIGS. 7A-8B, the outer portion of the insulation panel may include openings configured for receipt of a fastener or other like means to secure the insulation panel to a pipeline or other structure. The openings may be reinforced, e.g., grommets.

In some embodiments, the insulation panel may or may not include a cover having an outer portion. Further, the outer portion of the cover may extend along less than all the sides of the insulation panel, e.g., only along two opposing sides of the insulation panel. One or more sections of the outer portion may be larger than other sections of the outer portion, e.g., the outer portion may be wider in some sections than others. Further, one or more outer portions may extend only partially along a side of the insulation panel, e.g., one or more flaps may extend from a side of the insulation panel. The outer portion may also extend from a side of the insulation panel at the top, bottom, or anywhere in between. The outer portion may be any thickness, e.g., the thickness of the outer portion may be more or less than the thickness of the insulation material.

The cover 104 of the insulation panel 100 may be made from a variety of flexible materials capable of withstanding inclement weather conditions. The material of the cover 104 may be strong, tough, durable, lightweight, flexible (even at low temperatures), weather resistant, and/or waterproof. The material of the cover 104 may also be UV or sunlight resistant, tear/puncture resistant, chemical resistant, mildew resistant, insect/rodent resistant, and/or biodegradable. The cover 104 may also be repaired if punctured, torn, or otherwise damaged, such as with a heat sealable patch.

A fabric may be used for the cover 104 of the insulation panel 100. The fabric may be a coated fabric, such as the geo-membrane material used as pond or pit liners. The fabric material may be made, for example, of a medium or high density polyethylene, various polyesters, reinforced polyethylene, ethylene propylene diene monomer (EPDM), polyvinyl chloride (PVC), and/or polypropylene material. The fabric may be knitted, woven or nonwoven. The material may be a variety of weights, such as from about 5 to about 40 oz/sq yd. Other materials, such as Kevlar, may also be used for the cover 104 of the insulation panel 100.

As shown, the cover 104 of the insulation panel 100 is made from a geo-membrane material known as 8218 LTA Low Temperature Use Geomembrane, manufactured by Seaman Corporation. Test method details about this material can be found in Table 1 below and at http://www.xr-5.com/products/8218_LTA.html. The This material may be supplied in sheets, or rolls, with a nominal weight of 18 oz/sq yd. This material is capable of withstanding inclement weather conditions and is flexible at temperatures as low as −67 degrees F. This material is also waterproof, weather resistant, durable, tough, UV or sunlight resistant, and tear/puncture resistant.

TABLE 1

| 8218 LT | Standard | Metric |
|---|---|---|
| Base Fabric Type | Polyester | |
| Base Fabric Weight | 3.0 oz/yd² | 102 g/m² |
| (nominal) | | |
| Coating Type | Flexible PVC | |
| Finished Coated Weight | 18.0 + | 610 + |
| ASTM D751 | 2/−1 oz/yd² | 70/−35 g/m² |
| Tongue Tear | 8″ × 10″ | 20.3 cm × 25.4 |
| ASTM D751 | sample @ | cm sample @ |
| | 12 in/min | 30.5 cm/min |
| | 100/100 lb_{f} | 445/445 N |
| Grab Tensile | 230/200 lb_{f} | 1024/890 N |
| ASTM D751 | | |
| Strip Tensile | 200/140 lb_{f}/in | 178/125 |
| ASTM D751, | | daN/5 cm |
| Procedure B | | |
| Adhesion | 10 lb_{f}/in | 9 daN/5 cm |
| ASTM D751, | | |
| Dielectric Weld | | |
| Hydrostatic Resistance | 200 psi | 1.38 MPa |
| ASTM D751, | | |
| Procedure A | | |
| Low Temperature | Pass @ −67° F. | Pass @ −55° C. |
| ASTM D2136 | | |
| ⅛″ mandrel, 4 hr | | |
| Flame Resistance | | |

| | |
|---|---|
| FTMS 191A, | Sample not consumed |
| Method 5910 | within 2 minutes |

The cover 104 of the insulation panel 100 may be a variety of colors. The color of the cover 104 may affect the UV resistance and thermal properties of the insulation panel 100. For example, a black cover will tend to absorb more thermal radiation during the day than a lighter color. However, a lighter colored cover (e.g., white or light grey) may have better UV resistance than a darker colored cover.

The insulation material 102 of the insulation panel 100 may be a variety of flexible insulation materials capable of reducing heat loss from the pipeline or other structure. For example, the insulation material 102 may be selected to prohibit fluids (e.g., water) in a pipeline from freezing when the pipeline is exposed to low temperatures (e.g., −65 degrees F.). The insulation material 102 may be lightweight and have a uniform thickness and/or density, though this does not have to be the case. The thickness and/or density of the insulation material 102 preferably remains substantially unchanged over a period of time (e.g., 10-20 years). The insulation material 102 may be configured such that it does not slide or move within the cover 104 (e.g., downward) when wrapped around a pipeline. The insulation material 102 may also be flexible at low temperatures (e.g., −65 degrees F.) such that the insulation panel 100 may be wrapped around a pipeline in cold weather regions of the world. The insulation material 102 may be capable of being compressed (e.g., for packaging and/or transport) and then return substantially back to its original thickness and density when decompressed or released (e.g., for installation). In this form, insulation material 102 preferably includes the ability to be compressed, densified or otherwise deformed under pressure and the ability to return to its original density, state or form upon removal of the compressing force or pressure.

The insulation material 102 may include one or more pieces of fiberglass insulation or other insulation having an R-value per inch of thickness from about 2 to about 13 hr-sq ft-deg F/Btu or a K-value from about 0.08 to about 0.5 Btu-in/hr-sq ft-deg F, measured at 75 deg F. The R value of the insulation material 102 may be increased or decreased depending on the thickness of the insulation material. For example, doubling the thickness of the insulation material 102 may double the R value of the insulation material, tripling the thickness of the insulation material may triple the R value, and so forth. A wide variety of different types of insulation materials and combinations of different types of insulation materials may be used. Examples of suitable insulation materials include, but are not limited to foam, rock wool, and/or aerogels. In addition, the insulation material 102 may also comprise mineral, organic, cellulose, and/or polymer based insulation. Further, the insulation material 102 may comprise “blown-in” or loosefill insulation, such as AttiCat® Expanding Blown-In Fiberglass insulation manufactured by Owens Corning. Combinations of any of the aforementioned materials may also be used.

The insulation material 102 can be, in one embodiment, a unitary piece of TRS-40 fiberglass manufactured by Owens Corning. This insulation material has a nominal density of about 2.5 lb/cu ft. A 4 inch thick piece of this insulation material has an R-value from about 18.0 to about 18.4 hr-sq ft-deg F/Btu and a K-value from about 0.21 to about 0.23 Btu-in/hr-sq ft-deg F, measured at 75 deg F. This insulation material is flexible at low temperatures (e.g., −65 degrees F.). This insulation material is capable of being compressed and then return substantially back to its original thickness and density when decompressed or released. In other embodiments, multiple pieces of insulation having the same or different properties and shapes can be used inside cover 102 to form insulation material 102.

The insulation panel 100 may be manufactured in a variety of different ways. For example, one or more pieces of cover material may be wrapped around the insulation material. One or more sides of the cover material may then be fastened or sealed together to encase the insulation material. The sides of the cover material may be sealed or fastened in a variety of ways, e.g., with fasteners, adhesives, heat sealed, or the like. Further, one or more sides of the cover material may be fastened or sealed to form an outer portion along the sides of the cover.

In one embodiment, a single piece of cover material is wrapped around the top, bottom, and one side of the insulation material. The cover material is then sealed with heat around the remaining sides of the insulation material to form an outer portion of the cover. In another embodiment, the insulation material is sandwiched between two pieces of cover material. The two pieces of cover material are then fastened or sealed together to encase the insulation material. In yet another embodiment, one or more sides of the cover material are fastened or sealed together like a pouch or bag and then the insulation material is inserted into the cover. One or more openings may be placed in the cover material before or after the cover material is applied to the insulation material, e.g., openings may be punched in outer portion of the cover after the cover material is applied to the insulation material. In one embodiment, the cover material is heat shrunk onto a piece of insulation material to form the insulation panel.

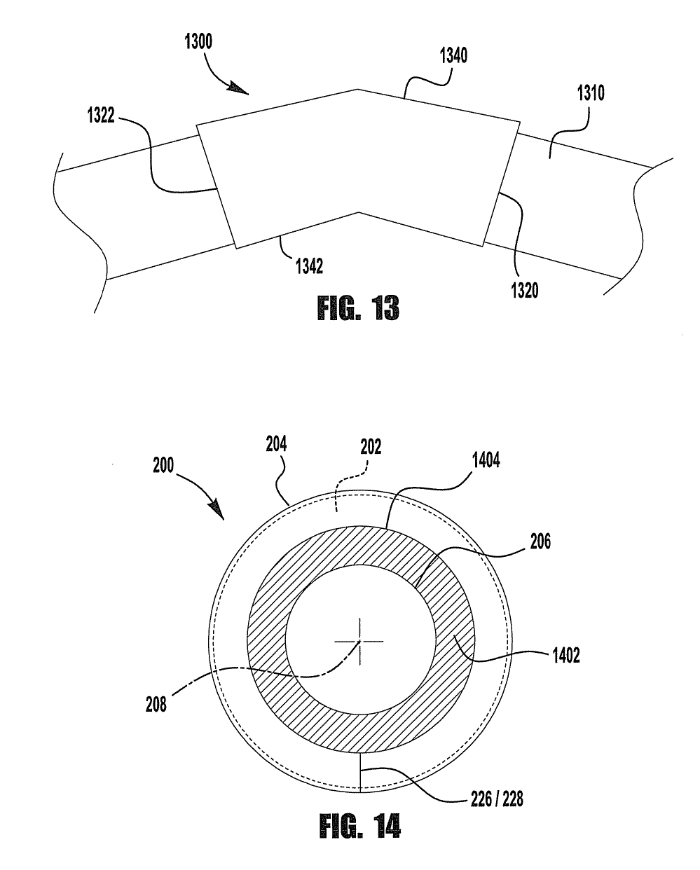

FIGS. 2A and 2B illustrate an insulation panel 200 installed on a pipeline 206. FIG. 2A is a side view and FIG. 2B is an end view of the insulation panel 200 installed on the pipeline 206. The pipeline 206 is shown for illustrative purposes and may include one or more components in addition to the pipe through which the fluid is intended to flow. For example, pipeline 206 may include existing insulation material 1402 (see FIG. 14) wrapped around the pipeline (e.g., encased in a hard outer shell 1404, as shown in FIG. 14) or a junction connecting two or more lengths of pipe together (see FIG. 4D).

When the insulation panel 200 is installed on a pipeline having existing insulation, the insulation panel may be installed over the existing insulation to provide additional insulation to the pipeline. As such, the insulation panel 200 may be used to increase the overall R value of the pipeline insulation, such as, for example, doubling or tripling the overall R value of the existing insulation. Other exemplary applications of the insulation panel 200 include insulating pipelines having no existing insulation or re-insulating pipelines in which the existing insulation is removed and replaced by one or more insulation panels.

In the embodiment shown, insulation panel 200 is wrapped around the circumference or outer surface of the pipeline 206 and about a longitudinal axis 208 of the pipeline. When installed, the bottom surface 218 of the insulation panel 200 contacts the outer surface of the pipeline 206 (see FIG. 2B) and the top surface 220 is exposed to the environment. In some embodiments, the portion of the cover 204 that includes the top surface 220 may be made of a different material or even the same material having characteristics (e.g., size, thickness, density, etc.) different from the portion of the cover that includes the bottom surface 218. For example, outer or top portion 220 of the cover 204 may be made of a material that is more durable than an inner or bottom portion 218 of the cover due to its exposure to the environment and other potential hazards.

Further, the insulation panel 200 is dimensioned such that the third and fourth sides 226 and 228 of the panel intersect or can overlap when the panel is wrapped around the pipeline 206. The intersection of the third and fourth sides 226 and 228 is shown at the bottom of the pipeline 206 in FIG. 2B. However, the insulation panel 200 may be positioned such that the intersection of the third and fourth sides 226 and 228 is at any location along the circumference of the pipeline 206 and, hence, the panel 200.

As discussed in more detail below in reference to FIGS. 6A-8B, the insulation panel 200 may be secured to pipeline 206 or other structures in a variety ways. For example, the third and fourth sides 226 and 228 may be secured together and/or to the pipeline 206 directly, the first and second sides 222 and 224 may be secured to the pipeline directly, and/or the first and second sides 222 and 224 may be secured to an adjacent insulation panel.

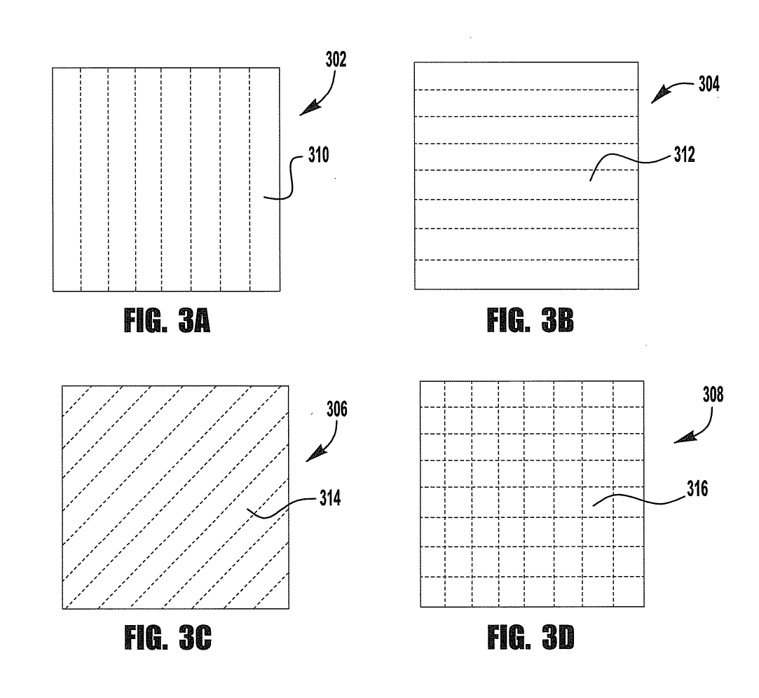

The insulation panel of the present application may include membranes that form pockets inside the panel configured to hold pieces of insulation material or “blown-in” insulation material in place within the panel. FIGS. 3A-3D illustrate various embodiments of insulation panels 302, 304, 306, and 308 having membranes that form pockets 310, 312, 314, and 316 within the insulation panel. For example, the insulation panel 302 of FIG. 3A includes vertical membranes forming vertical pockets 310 within the panel; the insulation panel 304 of FIG. 3B includes horizontal membranes forming horizontal pockets 312 within the panel; the insulation panel 306 of FIG. 3C includes angled membranes forming angled pockets 314 within the panel; and the insulation panel 308 of FIG. 3D includes a grid like structure of membranes forming pockets 316 within the panel. An insulation panel having more than one membrane structure or configuration is also possible such as, for example, a membrane structure that combines any one or more of the aforementioned membrane pockets 310, 312, 314 and 316 may be used.

However, the insulation panel of the present application may have a variety of other configurations of pockets within the panel to hold pieces of insulation material or “blown-in” insulation material in place within the panel. Further, the insulation material within the insulation panel may be secured to the cover such that the insulation material is held in place relative to the cover. The insulation material may be secured to the cover in a variety of ways, such as with one or more fasteners, adhesives, or the like.

The insulation panel of the present application may be shaped and configured in a variety of ways. For example, the insulation panel may be shaped and configured such that it may be installed around components of a pipeline, e.g., pipe junctions or support structures. The insulation panel may also be shaped and configured to insulate a pipeline of varying diameter (e.g., the transition area between pipes of different diameters). Further, the insulation panel may be shaped and configured to insulate the transition area between an above ground pipeline and below ground pipeline (e.g., the intersection of the pipeline and the surface) and bends in pipelines. The insulation panel may also be shaped and configured to insulate a bend in a pipeline or a non-straight section of a pipeline.

FIGS. 4A-4D and 13 illustrate various shapes and configurations of the insulation panel of the present application. An insulation panel 402 of FIG. 4A is trapezoidal in shape and has a first side 420, a second side 422, a third side 440, and a fourth side 442. One exemplary application for the insulation panel 402 is to insulate a pipeline of varying diameter. For example, the insulation panel 402 may be placed on top of the pipeline with the first side 420 positioned on the portion of the pipeline having the smaller diameter and the second side 422 positioned on the portion of the pipeline having the larger diameter. The third and fourth sides 440 and 442 of the insulation panel 402 may then be wrapped around the pipeline to insulate the transition area between the portions of the pipeline having varying diameters.

An insulation panel 404 of FIG. 4B is cross shaped and has four flap portions 424, 426, 428, and 430 extending from the central portion of the panel. One exemplary application for insulation panel 404 is to insulate a component of the pipeline. For example, the central portion of the insulation panel 404 may be placed on the top of the component and the flaps 424, 426, 428, and 430 wrapped around the sides and bottom of the component (e.g., similar to wrapping a band aid around the knuckle or tip of a finger of a person).

An insulation panel 406 of FIG. 4C is triangular in shape and has a tip portion 432, a first side 434, a second side 436, and a third side 438. One exemplary application for the insulation panel 406 is to insulate the intersection between the pipeline and the surface. For example, the insulation panel 406 may be placed on the top of the pipeline with the tip portion 432 positioned at the intersection between the pipeline and the surface and the first side 434 positioned on the pipeline. The second and third sides 436 and 438 of the insulation panel 406 may then be wrapped around the pipeline to insulate the exposed portion of the pipeline extending from the surface.

FIG. 4D is an end view of an insulation panel 408 installed on a component 412 of a pipeline 410. The component 412 of the pipeline 410 is shown for illustrative purposes and may be any component of a pipeline, such as, for example, a shell encasing existing insulation, the junction between two lengths of pipe, or a support structure for the pipeline. As shown, the component 412 of the pipeline 410 is supported by two legs 450 and 452. The insulation panel 408 is shaped and configured to wrap around the component 412 and includes openings or slots 416 and 418 that provide clearance for the legs 450 and 452 supporting the component 412.

FIG. 13 is a top view of an insulation panel 1300 installed on a pipeline 1310 having a bend or non-straight section. As shown, the insulation panel 1300 has a first side 1320, a second side 1322, a third side 1340, and a fourth side 1342. The first side 1320 is positioned on a first portion of the pipeline 1310 on one side of the bend or non-straight section and the second side 1322 is positioned on a second portion of the pipeline on the other side of the bend or non-straight section. The third and fourth sides 1340 and 1342 of the insulation panel 1300 are wrapped around the pipeline 1310 to insulate the bend or non-straight section of the pipeline. The third side 1340 of the insulation panel 1300 is wrapped around the longer outside of the bend or non-straight section and the fourth side 1342 is wrapped around the shorter inside of the bend or non-straight section.

The insulation panel may include one or more openings or slots in the cover. For example, an insulation panel 500 illustrated in FIG. 5 includes openings 506 in a cover 504 configured to permit air to escape from inside the cover when the insulation panel is compressed and/or rolled for shipment. This permits the panel to be compressed to a relatively thin dimension for efficient packaging and transportation where multiple panels may be packaged in the same space that would have been occupied by an uncompressed panel. The insulation panel 500 may also include one or more valves in openings 506 or other locations to control airflow into and out of the insulation panel. One or more of the openings 506 may be configured to permit attachment of a vacuum for removing air from the insulation panel 500 and/or a compressor for inflating the insulation panel, e.g., during installation. One or more of the openings 506 may also be used as a port to blow loosefill or “blown-in” fiberglass into the cover 504 of the insulation panel 500

The insulation panel may be secured to a pipeline or other structure in a variety of ways. One exemplary method includes securing two sides of the insulation panel together when the panel is wrapped around the pipeline. FIG. 6A illustrates an end view of an insulation panel 600 wrapped around a pipeline 618. As shown, a first side 626 and a second side 628 of the insulation panel 600 may be secured together with a first connector 630 to prohibit removal of the panel from the pipeline 618. The first connector 630 may be a variety of devices capable of securing the first and second sides 626 and 628 of the insulation panel 600 together. For example, the first connector 630 may be one or more fasteners (e.g., a bolt, clip, pin, hook and loop, or the like) or an elongated flexible member, such as a rope, cord, chain, or the like. The first connector 630 may also be a piece of flexible or non-flexible material, such as a plate, that is attached to both the first and second sides 626 and 628 to secure the sides together. Further, the first and second sides 626 and 628 of the insulation panel 600 may overlap to permit installation of the panel on pipelines of various diameters.

The insulation panel of the present application may include flanges or flaps on one or more sides of the panel for securing the panel to a pipeline. One or more of the flanges or flaps may be positioned along the length of a side or a single flange or flap may run the entire length of the side. FIG. 7A illustrates an insulation panel 700 having a first flange 726 with one or more openings 730 and a second flange 728 with one or more openings 732. The first and second flanges 726 and 728 are located on two opposing sides of the insulation panel 700. The openings 730 and 732 in the first and second flanges 726 and 728 may be reinforced, e.g., grommets. The openings 730 and 732 may be configured for receipt of one or more fasteners.

FIGS. 7B and 7C illustrate the insulation panel 700 installed on a pipeline 718. FIG. 7B is a side view and FIG. 7C is an end view of the insulation panel 700 installed on the pipeline 718. As shown, the insulation panel 700 is wrapped around the circumference or outer surface of the pipeline 718 and about a longitudinal axis 708 of the pipeline. When installed, the first and second flanges 726 and 728 of the insulation panel 700 are configured to meet at the bottom of the pipeline 718 to secure the opposing sides of the panel together. However, the insulation panel 700 may be positioned such that the first and second flanges 726 and 728 meet at any location around the circumference of the pipeline 718 (e.g., top or sides). As shown, the openings 730 and 732 in the first and second flanges 726 and 728 are substantially aligned such that one or more fasteners or an elongated flexible member, such as a rope, cord, chain, or the like, may be used to fasten the flanges together and secure the insulation panel 700 to the pipeline 718. As shown in FIG. 7C, a fastener 740 passes through openings 730 and 732 in the first and second flanges 726 and 728 to fasten the flanges together.

Another exemplary method of securing the insulation panel of the present application to a pipeline includes securing one or more sides of the panel to the pipeline or component of the pipeline. This exemplary method may prohibit the insulation panel from moving longitudinally relative to the pipeline. FIG. 6B illustrates a side view of the insulation panel 600 installed on the pipeline 618. As shown, a third side 638 and a fourth side 640 of the insulation panel 600 may be secured to the pipeline 618 with a second connector 632 and a third connector 634, respectively. The second and third connectors 632 and 634 may be a variety of devices capable of securing the third and fourth sides 638 and 640 of the insulation panel 600 to the pipeline 618. For example, the second and/or third connectors 632 and 634 may be one or more fasteners, such as a bolt, clip, pin, or the like, that attaches the side of the insulation panel 600 to the pipeline 618. Further, the second and/or third connectors 632 and 634 may include an elongated flexible member, such as a rope, cord, chain, or the like, that secures the side of the insulation panel 600 around the pipeline 618. The third and fourth sides 638 and 640 and/or the second and third connectors 632 and 634 may be configured to permit installation of the insulation panel 600 on pipelines of various diameters.

FIG. 8A illustrates an insulation panel 800 having a first flange 826 with one or more openings 830 and a second flange 828 with one or more openings 832. The first and second flanges 826 and 828 are located on two opposing sides of the insulation panel 800. The openings 830 and 832 in the first and second flanges 826 and 828 may be reinforced, e.g., grommets. The openings 830 and 832 may be configured for receipt of one or more fasteners (e.g., a bolt, clip, pin, or the like) or an elongated flexible member, such as a rope, cord, chain, or the like.

FIG. 8B illustrates a side view of an insulation panel embodiment 800 installed on a pipeline 818 or other similar structure. The insulation panel 800 is wrapped around the circumference or outer surface of the pipeline 818 and about a longitudinal axis 808 of the pipeline. When installed, the first and second flanges 826 and 828 of the insulation panel 800 are configured to wrap around the circumference or outer surface of the pipeline 818. As shown, two lengths of elongated flexible members 850 and 852 are threaded through the openings 830 and 832 in the first and second flanges 826 and 828, respectively. The lengths of the elongated flexible members 850 and 852 may be tightened to draw the first and second flanges 826 and 826 against the outer surface of the pipeline 818 to secure the insulation panel 800 to the pipeline. The lengths of the elongated flexible members 850 and 852 may be tightened or loosened such that the insulation panel 800 may be secured to pipelines of various diameters. Further, the arrangement of the openings 830 and 832 in the first and second flanges 826 and 828 may permit the insulation panel 800 to be secured to pipelines of various diameters.

As described above, the insulation panel of the present application may secured to the pipeline such that the fastening means is located at any location about the circumference or outer surface of the pipeline, e.g., towards the bottom, on either side, or on top of the pipeline. With the fastening means located near the bottom of the pipeline, any moisture that builds up between the pipeline and the insulation panel may be permitted to drain out between the sides of the panel located towards the bottom of the pipeline. For example, as shown in FIG. 6A, moisture may be permitted to drain out between the first side 626 and the second side 628 of the insulation panel 600. However, locating the fastening means on the sides or top of the pipeline may discourage theft or removal of the insulation panel because the fastening means are more difficult to access.

The insulation panels of the present application may also include features that discourage tampering, theft, or sabotage of the panel. For example, one or more of the fasteners used to secure the insulation panel to the pipeline may be tamper proof. One exemplary tamper proof fastener includes a bolt with a unique head requiring a special tool to remove the fastener (e.g., a bolt with a pentagonal head having a pin in the middle). The cover of the insulation panel may also be made of tear or cut resistant material to discourage cutting the panel around one more of the openings used to secure the panel to the pipeline. Further, a fence or cage may be placed or wrapped around the insulated panels of the pipeline in populated areas to discourage access to the pipeline.

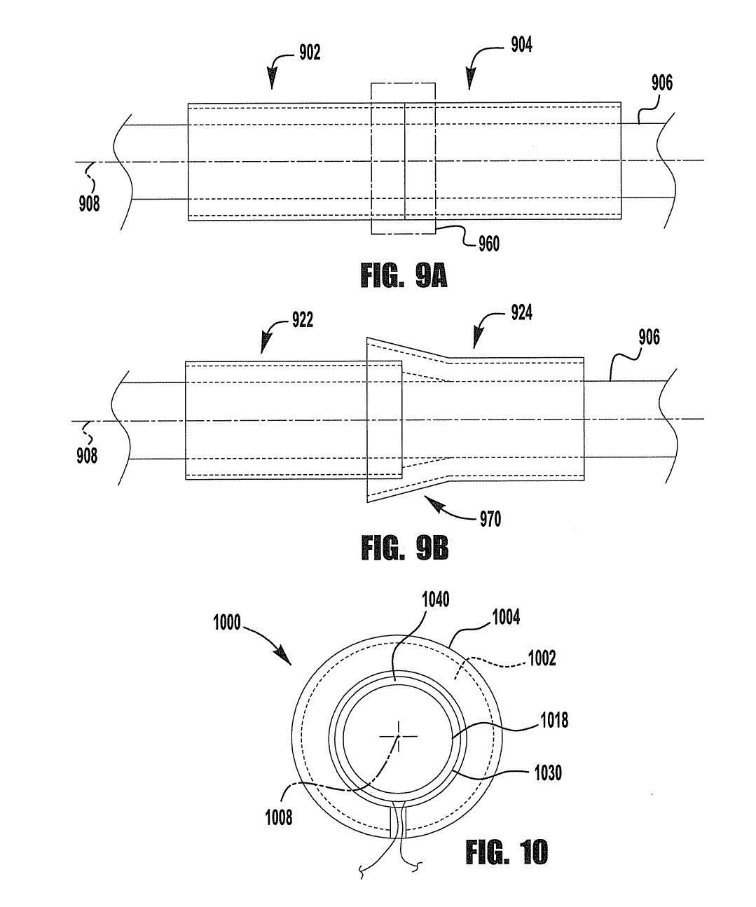

The insulation panels may be connected to one or more adjacent insulation panels on the pipeline to form a long continuous insulated pipeline or other structure. The adjacent insulation panels may also be configured to prohibit insulation gaps between the panels when installed on a pipeline. For example, FIG. 9A illustrates a first insulation panel 902 and a second insulation panel 904 installed on a pipeline 906. The insulation panels 902 and 904 are wrapped around the circumference or outer surface of the pipeline 906 and about a longitudinal axis 908 of the pipeline. As shown, a connector 960 may be used to connect the insulation panels 902 and 904 together, e.g., fastening the intersecting sides of the panels together. The connector 960 may be a variety of devices capable of connecting the insulation panels 902 and 904 together. For example, the connector 960 may include one or more fasteners (e.g., a bolt, clip, pin, Velcro, or the like) or an elongated flexible member, such as a rope, cord, chain, or the like. The connector 960 may also be a piece of flexible or non-flexible material, such as a plate, that is attached to both the first and second insulation panels 902 and 904 to secure the panels together.

Adjacent insulation panels may also be shingled to prohibit insulation gaps between the panels when installed on a pipeline. For example, FIG. 9B illustrates a first insulation panel 922 and a second insulation panel 924 installed on a pipeline 906. The insulation panels 922 and 924 are wrapped around the circumference or outer surface of the pipeline 906 and about a longitudinal axis 908 of the pipeline. As shown, a portion 970 of the second insulation panel 924 overlaps the intersecting side of the first insulation panel 922. This overlap of the adjacent insulation panels 922 and 924 prohibits any insulation gap between the panels. As described above, a connector may be used to connect the adjacent insulation panels 922 and 924 together, e.g., wrapping an elongated flexible member, such as a rope, cord, chain, or the like, around the overlap portion.

The insulation panels may be used with a heat source, such as a point or distributed heat source. The heat source may be positioned between the insulation panel and the outer surface of the pipeline. The heat source may be configured to keep the space between the outer surface of the pipeline and the inner surface of the insulation panel at a selected temperature. With the outer surface of the pipeline held at a substantially constant and known temperature by use of the heat source, the insulation panel may require less insulation material to prohibit the fluid in the pipeline from freezing.

The amount of energy required by a heat source to maintain the outer surface of the pipeline at a selected temperature varies based on a variety of factors, e.g., the selected temperature maintained, the outside temperature, and the amount of insulation material in the insulation panel. For example, less energy is required to maintain the outer surface of the pipeline at a low temperature than at a higher temperature; however, the insulation panel may require more insulation material to prohibit the material in the pipeline from freezing. Further, the additional heat provided by the heat source may not be required when the outside temperature is above the selected temperature, e.g., during the summer months. Thus, the heat source may be turned on or off depending on the outside temperature. The heat source may be controlled automatically through the use of temperature sensors and switches. In some embodiments, the heat source may be at least be partially powered by solar energy.

One exemplary heat source is an electrical heat source that includes one or more wires positioned between the outer surface of the pipeline and the inner surface of the insulation panel. The electrical heat source may be integrated with the insulation panel and include one or more of the wires printed on the inner surface of the cover. The electrical heat source may also be separate from the insulation panel. For example, FIG. 10 illustrates an end view of an insulation panel 1000 installed on a pipeline 1018. The insulation panel 1000 is wrapped around the circumference or outer surface of the pipeline 1018 and about a longitudinal axis 1008 of the pipeline. As shown, a wire 1030 of an electrical heat source is positioned in the space 1040 between the outer surface of the pipeline 1018 and the inner surface of the insulation panel 1000. The electrical heat source is configured to keep the space 1040 between the outer surface of the pipeline 1018 and the inner surface of the insulation panel 1000 at a selected temperature. As such, the insulation panel 1000 is “heated” by use of the electrical heat source. A combination of “heated” and “non-heated” insulation panels may be used to insulate a pipeline.

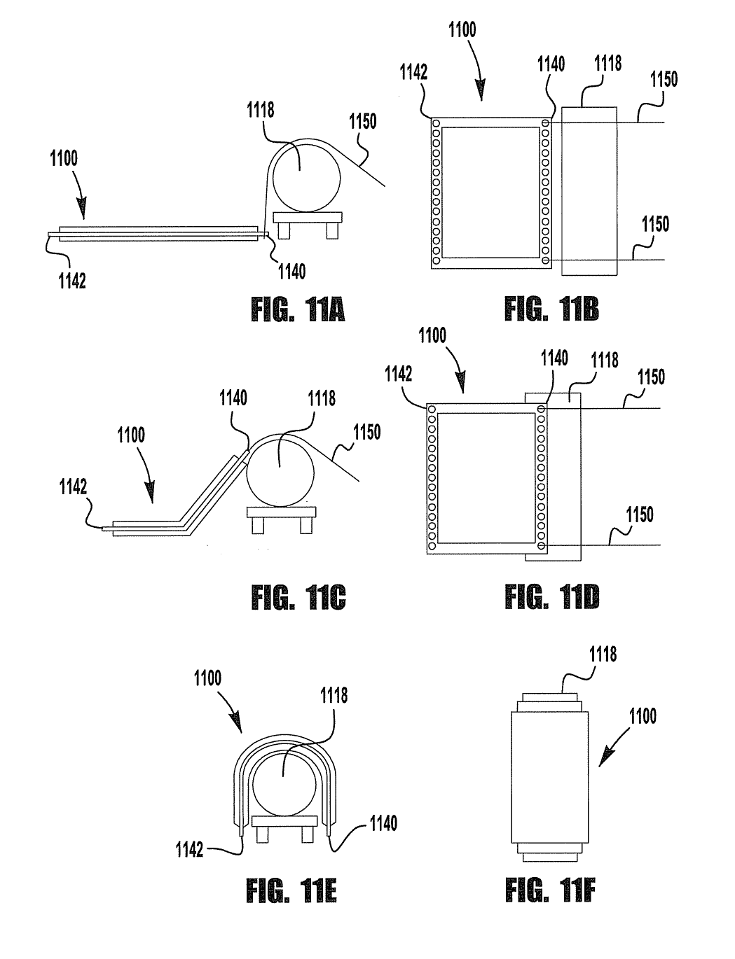

One exemplary method of installing an insulation panel of the present application on a pipeline is described below and illustrated in FIGS. 11A-11F. The exemplary method includes preparing an insulation panel 1100 for shipment and delivery to a pipeline 1118. For example, the insulation panel may be compressed and/or rolled prior to shipment. In the compressed or rolled configuration, the insulation panel takes up less space during shipment and permits more insulation panels to be shipped and delivered at one time. Alternatively, the insulation panel can be compressed and stacked for shipment. As discussed above, the insulation panel may include openings in the cover to permit air to escape from inside panel when the panel is compressed and/or rolled or stacked. The insulation panel may also include one or more valves to control airflow into and out of the insulation panel. A vacuum may be applied to the insulation panel to remove air within the panel and compress the panel.

Once the insulation panel 1100 is delivered to the installation site, the panel is positioned on one side of the pipeline 1118 and unrolled. The insulation panel 1100 is allowed to decompress and return substantially to its original shape, thickness, and density (i.e., original uncompressed state). The insulation panel may return to its original state naturally over a period of time. Further, a compressor may be used to blow air into the insulation panel to assist with decompression of the panel. As illustrated in FIGS. 11A (side view) and 11B (top view), one or more elongated flexible members 1150 are removably attached to a first end 1140 of the insulation panel 1100. The one or more elongated flexible members 1150 are tossed over the top of the pipeline 1118 to the other side of the pipeline.

The insulation panels of the present application are generally of a size and weight that they can be installed on the pipeline or similar structure by two people. As illustrated in FIGS. 11C (side view) and 11D (top view), the one or more elongated flexible members 1150 attached to the first end 1140 of the insulation panel 1100 are used to pull the panel over the top of the pipeline 1118. As illustrated in FIGS. 11E (side view) and 11F (top view), the insulation panel 1100 is draped over the top of the pipeline 1118 with the first and second ends 1140 and 1142 of the panel hanging downward and the inner surface of the panel contacting the outer surface of the pipeline. The insulation panel 1100 is then adjusted and positioned relative to the pipeline 1118, pipeline component, or any adjacent insulation panel. The one or more elongated flexible members 1150 are removed from the first end 1140 of the insulation panel 1100.

The insulation panel 1100 is positioned such that panel may be secured to the pipeline 1118, pipeline component, or adjacent insulation panel by any means disclosed in the present application. For example, the two hanging ends or sides 1140 and 1142 of the insulation panel 1100 may be positioned such that they can be fastened together. The insulation panel 1100 is fastened or secured to the pipeline 1118, pipeline component, or adjacent insulation panel by any means disclosed in the present application. For example, one or more elongated flexible members may be used to fasten the hanging ends or sides 1140 and 1142 of the panel 1100 together. One or more elongated flexible members may also be used to secure the insulation panel 1100 around the outer surface of the pipeline 1118.

A second insulation panel may be installed on the pipeline 1118 adjacent to the first insulation panel 1100 by repeating the steps outlined above. The second insulation panel may be positioned relative to the first insulation panel 1100. For example, the second insulation panel may be positioned to butt up against or overlap the first insulation panel 1100. The second insulation panel may be secured to the pipeline 1118, pipeline component, or first insulation panel 1100 by any means disclosed in the present application.

A heat source may be installed on the pipeline 1118 prior to installation of the insulation panel 1100. For example, the wires of an electrical heat source may be wrapped around the pipeline 1118 prior to installation of the insulation panel 1100. The wires may be connected to the electrical heat source. Further, if the wires of the electrical heat source are printed on the inner surface of the insulation panel 1100, installation of the panel may require connecting the wires to an electrical heat source.

As mentioned above, the insulation panel of the present application may be used to insulate a variety of objects, such as tanks, vessels, trailers, or railroad tank cars. Application to these objects is illustrated in FIGS. 2A and 2B, with the pipeline 206 replaced by the tank, vessel, etc.

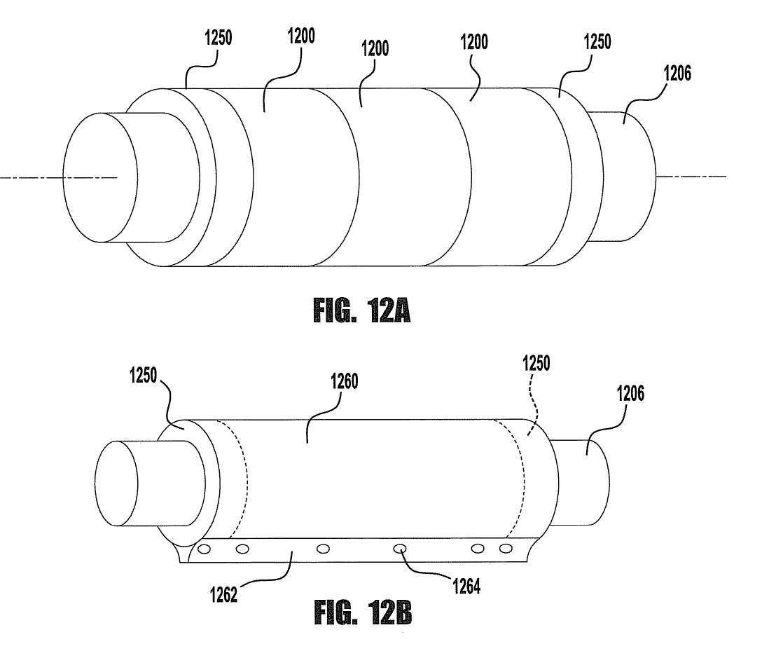

FIGS. 12A and 12B illustrate a plurality of insulation panels of the present application installed on a pipeline. As illustrated in FIG. 12A, three insulation panels 1200 are installed on a pipeline 1206 with a seal ring 1250 at each end. As illustrated in FIG. 12B, the plurality of insulation panels 1200 are covered by an overwrap 1260 that provides long term weather and UV protection to the panels. As such, the overwrap 1260 covers the seams between the insulation panels 1200. With the seams between the panels 1200 covered by the overwrap 1260, the potential of water getting in and damaging the insulation material of the panels is reduced.

The insulation panels 1200 may be similar to the insulation panel 100 described above. In one embodiment, the insulation panels 1200 include insulation material encased within a cover or jacket. The cover of the insulation panels 1200 may be lightweight and configured to protect the insulation material during shipment and installation. The cover may also be configured such that the panel 1200 may be vacuum sealed. As such, the insulation panels 1200 may be compressed for shipping by evacuating the air within the panel, as described above. In another embodiment, the insulation panels 1200 do not include a jacket or cover. Instead, only the insulation material of the panel 1200 is installed on the pipeline 1206.

The seal rings 1250 positioned at each end of the insulation panels 1200 installed on the pipeline 1206 may be made of a variety of materials. For example, in one embodiment, the seal ring 1250 is made of an insulating foam, such as polystyrene or polyurethane. In another embodiment, the sealing ring 1250 is made of a fiberglass composite. The seal ring 1250 may also include one or more gasketed sealing surfaces to seal the ring relative to the pipeline 1206, panels 1200, and/or overwrap 1260.

As illustrated in FIG. 12B, once the insulation panels 1200 and the sealing rings 1250 are installed on the pipeline 1206, the overwrap 1260 is draped over the panels to cover the panels and the sealing rings. The overwrap 1260 may be made of the various cover materials described above to provide long term weather and UV protection to the panels 1200. Further, the overwrap 1260 may be sealed at either end against the pipeline 1206 and/or a pipeline support structure. The overwrap 1260 may also be sealed at either end against the sealing rings 1250. The overwrap 1260 may be fastened to the pipeline 1206 and/or insulation panels 1200 by any of the various methods described above. For example, as illustrated in FIG. 12B, the sides 1262 of the overwrap 1260 are secured together towards the bottom of the pipeline 1206. The sides 1262 of the overwrap 1260 comprise openings 1264, such as grommets, that permit the sides of the overwrap to be fastened together, such as with an elongated flexible member, a fastener, or the like. Examples of an elongated flexible member include, but are not limited to, a rope, chain, cord, or the like. In some embodiments, the sealing rings 1250 are not used and the overwrap 1260 covers only the insulation panels 1200, including the ends of the insulation panels.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. For example, where components are releasably or removably connected or attached together, any type of releasable connection may be suitable including for example, locking connections, fastened connections, tongue and groove connections, etc. Still further, component geometries, shapes, and dimensions can be modified without changing the overall role or function of the components. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

We claim:

1. A method of adding insulation to a pipeline having an existing insulation system that comprises insulation disposed around a pipe of the pipeline and a hard shell that encases the insulation disposed around the pipe, the method of adding insulation comprising:
delivering an insulation panel to the pipeline, the insulation panel comprising:
one or more pieces of compressible fiberglass insulation material having an R value per inch of thickness from about 2 to about 13 hr-sq ft-deg F/Btu measured at 75 degrees Fahrenheit, the insulation material configured to return substantially back to its original thickness and density after being compressed;
a substantially rectangular coated fabric cover encasing the one or more pieces of insulation material, the coated fabric cover having a weight from about 5 to about 40 oz/sq yd;
a first row of spaced apart apertures disposed along a first side of the coated fabric cover; and
a second row of spaced apart apertures connected to the coated fabric cover, wherein the second row of spaced apart apertures is generally parallel to the first row of spaced apart apertures;
attaching one or more elongated flexible members to at least one of the apertures;
tossing the one or more elongated flexible members over the top of the existing insulation system;
using the one or more elongated flexible members to pull the insulation panel over the top of the hard shell of the existing insulation system such that the insulation panel is draped over the top of the hard shell of the existing insulation system; and
attaching apertures of the first row of spaced apart apertures to apertures of the second row of spaced apart apertures to secure the coated fabric cover around the existing insulation system.

2. The method of claim 1 further comprising installing a second insulation panel on the existing insulation system adjacent to the insulation panel.

3. The method of claim 1 further comprising installing an overwrap over the insulation panel and fastening the overwrap to the existing insulation system.

4. The method of claim 1, wherein the cover of the insulation panel has at least one vent that permits air to escape from inside the cover when the insulation panel is compressed, and the method further comprises compressing the insulation panel prior to delivering the insulation panel to the pipeline.

5. The method of claim 4 further comprising opening the vent to decompress the insulation panel such that the insulation panel returns substantially back to its original thickness.

6. The method of claim 1, wherein the coated fabric cover of the insulation panel comprises a geo-membrane material having a polyester fabric and a PVC coating.

7. The method of claim 1 further comprising overlapping first and second ends of the insulation panel before securing the coated fabric cover around the existing insulation system.

8. A pipeline, comprising:
a pipe;
insulation disposed around the pipe;
a hard outer shell that encases the insulation disposed around the pipe; and
a plurality of insulation panels secured around the hard outer shell that encases the insulation disposed around the pipe, wherein at least one of the plurality of insulation panels comprises:
one or more pieces of compressible fiberglass insulation material having an R value per inch of thickness from about 2 to about 13 hr-sq ft-deg F/Btu measured at 75 degrees Fahrenheit, the insulation material configured to return substantially back to its original thickness and density after being compressed;
a substantially rectangular coated fabric cover encasing the one or more pieces of insulation material, the coated fabric cover having a weight from about 5 to about 40 oz/sq yd; and
at least one vent in the coated fabric cover.

9. The pipeline of claim 8 further comprising a first row of spaced apart apertures disposed along a first side of the coated fabric cover and a second row of spaced apart apertures attached to the coated fabric cover, wherein the at least one of the plurality of insulation panels is secured around the hard outer shell by attaching apertures in the first row of apertures to apertures in the second row of apertures.

10. The pipeline of claim 9, wherein the second row of spaced apart apertures is generally parallel to the first row of spaced apart apertures.

11. The pipeline of claim 8 further comprising an overwrap installed over the plurality of insulation panels.

12. The pipeline of claim 8, wherein the vent comprises an opening in the cover.

13. The pipeline of claim 8, wherein the vent comprises a valve configured to control the airflow into and out of the cover.

14. The pipeline of claim 8, wherein the coated fabric cover of the at least one of the plurality of insulation panels comprises a geo-membrane material having a polyester fabric and a PVC coating.

15. The pipeline of claim 8, wherein at least two opposing sides of the at least one of the plurality of insulation panels overlap when the insulation panel is wrapped around the hard outer shell that encases the insulation disposed around the pipe.

16. The pipeline of claim 8, wherein at least two opposing sides of the at least one of the plurality of insulation panels are fastened together when the insulation panel is installed on the hard outer shell that encases the insulation disposed around the pipe.

17. The pipeline of claim 8, wherein a four inch thick piece of the one or more pieces of compressible fiberglass insulation material has an R value from about 18.0 to about 18.4 hr-sq ft-deg F/Btu measured at 75 degrees Fahrenheit.

18. An insulation panel for adding insulation to a pipeline having an existing insulation system that comprises insulation disposed around a pipe of the pipeline and a hard shell that encases the insulation disposed around the pipe, the insulation panel comprising:
one or more pieces of compressible fiberglass insulation material having an R value per inch of thickness from about 2 to about 13 hr-sq ft-deg F/Btu measured at 75 degrees Fahrenheit, the insulation material configured to return substantially back to its original thickness and density after being compressed;
a substantially rectangular coated fabric cover encasing the one or more pieces of insulation material, the coated fabric cover having a weight from about 5 to about 40 oz/sq yd;
a first row of spaced apart apertures disposed along a first side of the coated fabric cover;
a second row of spaced apart apertures connected to the coated fabric cover, wherein the second row of spaced apart apertures is generally parallel to the first row of spaced apart apertures, and wherein the first and second rows of spaced apart apertures are configured such that attachment of apertures of the first row of apertures to apertures of the second row of apertures secures the coated fabric cover around the pipeline; and
at least one vent in the coated fabric cover that permits air to escape from inside the cover when the insulation panel is compressed.

19. The insulation panel of claim 18, wherein the at least one vent is a hole in the coated fabric cover.

20. The insulation panel of claim 18, wherein the coated fabric cover comprises a geo-membrane material.

21. The insulation panel of claim 20, wherein the geo-membrane material is a polyester fabric having a PVC coating.

22. The insulation panel of claim 21, wherein the geo-membrane material has a nominal weight of about 18 oz/sq yd.

23. The insulation panel of claim 18, wherein the apertures of the first and second rows of apertures are reinforced with grommets.

24. The insulation panel of claim 18 wherein the vent comprises a valve configured to control the airflow into and out of the cover.

25. The insulation panel of claim 18, wherein at least two opposing sides of the insulation panel overlap when the insulation panel is wrapped around the pipeline.

26. The insulation panel of claim 18, wherein at least two opposing sides of the insulation panel are configured to overlap to permit installation of the insulation panel on pipelines of various diameters.

27. The insulation panel of claim 18, wherein at least two opposing sides of the insulation panel are fastened together when the insulation panel is installed on the pipeline.

28. The insulation panel of claim 18, wherein the coated fabric cover is light grey and UV resistant.

29. The insulation panel of claim 18, wherein the cover is repairable with a heat sealable patch.

30. The insulation panel of claim 18, wherein a four inch thick piece of the one or more pieces of compressible fiberglass insulation material has an R value from about 18.0 to about 18.4 hr-sq ft-deg F/Btu measured at 75 degrees Fahrenheit.

31. An insulation panel for adding insulation to a pipeline having an existing insulation system that comprises insulation disposed around a pipe of the pipeline and a hard shell that encases the insulation disposed around the pipe, the insulation panel comprising:
one or more pieces of compressible fiberglass insulation material having an R value per inch of thickness from about 2 to about 13 hr-sq ft-deg F/Btu measured at 75 degrees Fahrenheit, the insulation material configured to return substantially back to its original thickness and density after being compressed; and
a means for protecting the compressible fiberglass insulation material and attaching the insulation panel to the existing insulation system.
